(19) United States
(12) Patent Application Publication
(10) Pub. No.: US 2026/0308864 A1
(43) Pub. Date: Oct. 8, 2026

(54) SYSTEM AND METHOD FOR FORMING AN ANCHORAGE CONFIGURED TO FASTEN A VERTICAL MAST OF A CRANE

(71) Applicant: Manitowoc Crane Group France, DARDILLY (FR)

(72) Inventors: Bruno Roni-Damond, Lyon (FR); Philippe Peyron, Saint Nizier D'Azergues (FR); Stéphane Dumont, Chauffailles (FR)

(21) Appl. No.: 19/641,341

(22) Filed: Apr. 7, 2026

(30) Foreign Application Priority Data
Apr. 8, 2025 (FR) FR2503698

(51) Int. Cl. E02D 27/42; E02D 5/80; E02D 27/10

(52) U.S. Cl. CPC E02D 27/42; E02D 5/808; E02D 27/10; E02D 2250/0023; E02D 2600/30

(57) ABSTRACT

A system for forming an anchorage configured to fasten the lower legs of a vertical mast of a crane to an upper face of a concrete foundation mass includes a plurality of casting bases, each with a lower plate to be embedded into the foundation mass and connecting sleeves connected to the lower plate and encased into the foundation mass. A geometric adjustment device removably interconnects the casting bases with each other with a plurality of upper plates contacting the connecting sleeves. Each connecting sleeve internally delimits an isolated pocket. Anchoring bars, each screwed onto a lower plate and extending over an upper plate to protrude above the upper face of the foundation mass, removably extend into the pockets delimited by the connecting sleeves. Clamping elements create a load from the upper plates to the lower plates so as to clamp the connecting sleeves.

### FIELD OF THE DISCLOSURE

The present disclosure concerns the field of construction, in particular a system for forming an anchorage configured to fasten the lower legs of a vertical mast of a crane to an upper face of a concrete foundation mass, including a plurality of casting bases at least partially cast into the concrete.

The present disclosure also concerns a method for forming an anchorage making it possible to fasten the lower legs of a vertical mast of a crane to the upper face of a concrete foundation mass, the method including placing such a system so that the casting bases rest on a fixed ground within a terrestrial reference frame.

The present disclosure also concerns a method for fastening the lower legs of a vertical mast of a crane to the upper face of a concrete foundation mass.

The present disclosure finds application, in particular, in providing an anchorage for tower cranes, such as fixed cranes, rotating tower cranes, tower cranes with horizontal arms, tower cranes with articulated arms, self-climbing cranes, and cranes with inclined booms.

### BACKGROUND

In the field of construction, it is known to carry out non-recoverable leg anchorages for installing by screwing to the ground a vertical mast of a crane.

Typically, in this type of mounting the assembly of the legs must be positioned with high precision within the reinforcement of the foundation mass in all directions of a three-dimensional space. The assembly is mounted in such a way that a lower part of a mast or a specially prepared support to assist in positioning the legs on a blinding concrete allows the reinforcement to be placed around the legs, followed by the introduction of the concrete required for the foundation mass itself.

However, this technique is not entirely satisfactory. First, it immobilizes the mast during the pouring and the curing of the concrete. In addition, it frequently occurs that mounting the casting legs in this way leads to excessive positioning deviations, which may render these legs unsuitable for use in fastening vertical crane masts.

Furthermore, the casting of the anchoring legs into the concrete means that the stresses exerted on the vertical mast of a crane are transmitted to the anchoring legs and create shear stresses at the interface between the concrete and the legs, which may result in risks of dislocation of the foundation mass and instability of the vertical crane mast.

Successfully resolving all or part of these problems may involve destroying the mounting and starting over, which implies delays in the construction site, obvious economic losses, as well as significant noise pollution for residents and an increase in the environmental footprint of the construction site.

In addition, the mounting of non-recoverable casting legs for fastening the vertical mast of a crane implies loss of the fastening points, such as anchoring bars, within the foundation mass. However, these fastening points may generally include high-grade materials having significant financial and technical value. As a result, these existing solutions are unsatisfactory from an economic and environmental perspective.

Furthermore, the placement of the anchoring legs to be cast into the concrete is carried out by operators handling within the pit where the concrete is poured. This is therefore neither ergonomic nor safe, as there are risks of tipping or crushing.

Consequently, there is a need to provide a solution making it possible to address all these issues in the most economical, simple, and efficient way possible.

### SUMMARY

The present disclosure is directed to a system for forming an anchorage configured to fasten the lower legs of a vertical mast of a crane to an upper face of a concrete foundation mass which addresses all or part of the issues raised above.

In particular, present disclosure is directed to a system for forming an anchorage configured to fasten the lower legs of a vertical mast of a crane to an upper face of a concrete foundation mass of the aforementioned type, making it possible to:
promote a precise three-dimensional positioning of the anchoring bars for the temporary fastening of vertical masts of cranes,
ensure that some of the elements of the system are removable and reusable,
ensure that the system is transportable and can be positioned before the manufacture of the foundation mass,
facilitate and improve the reliability of implementation,
limit the risk of separation between the foundation mass and the anchoring bars,
provide an economical, safe, ergonomic, simple and effective solution,
provide a solution that allows recovery of a maximum of high-alloy metal materials in order to reduce its environmental footprint,
allow the dismantling, with less energy, of the anchoring bars having high technical and economic value for their reuse in another system for forming an anchorage according to the present disclosure,
limit the amount of high environmental-impact metal alloy lost within the foundation mass after construction work, and
avoid the conventional use of the lower part of a vertical mast for the geometric positioning of anchoring bars in a foundation mass.

This aim may be achieved by providing a system for forming an anchorage configured to fasten the lower legs of a vertical mast of a crane to an upper face of a concrete foundation mass, the system including:
a plurality of casting bases in which the number of casting bases is greater than or equal to 3, each of the casting bases including:
   a lower plate intended to be embedded into the foundation mass,
   a plurality of connecting sleeves extending from the lower plate and intended to be at least partially encased in the foundation mass,
a geometric adjustment device, interconnecting in a removable manner the casting bases with each other, intended to be arranged above the upper face of the foundation mass and including a plurality of upper plates, each upper plate being associated with one of the casting bases and being positioned in contact with the connecting sleeves of the casting base which is associated with it, so that for each casting base, the connecting sleeves connect the upper plate and the lower plate and each connecting sleeve internally delimits a pocket intended to be isolated from the foundation mass,
a plurality of anchoring bars having a first end fasten by screwing to the lower plate of one of the casting bases and a second end extending above the upper plate on a side opposite the lower plate and intended to protrude above the upper face of the foundation mass, each anchoring bar extending along one of the pockets delimited by the connecting sleeves in a manner removable from the connecting sleeve which surrounds it, and
a plurality of clamping elements screwed onto the second ends of the anchoring bars and each intended to create, at one of the casting bases, a load from the upper plate toward the lower plate so as to clamp the connecting sleeves.

The technical provisions described above make it possible to provide a system with multiple casting bases, enabling a good distribution of the forces and conferring good stability to the anchorage. The system is advantageously made up of elements that are permanently embedded into the foundation mass (essentially the casting bases), and other elements that may advantageously be dismounted and recovered once the lower legs of a vertical mast no longer need to be fastened to the foundation mass, namely the geometric adjustment device, the anchoring bars, and the clamping elements. All of these elements may then be reused subsequently for another fastening of another vertical mast of a crane at another location. This represents significant financial savings and a real environmental advantage by avoiding loss and pollution. This is all the more important because the anchoring bars may be made of high-grade steel, and their post-construction recovery is therefore particularly significant. The reuse of the anchoring bars is a direct recycling, for identical use without any loss of value of the anchoring bars. The dismantling of the anchoring bars for recycling is carried out with minimal energy and without the use of machinery. To this end, the presence of the connecting sleeves, which isolate the anchoring bars from the concrete of the foundation mass, is particularly advantageous in allowing the dismantling of the anchoring bars and their recovery by simple unscrewing relative to the lower plates followed by upward pull. The presence of the geometric adjustment device, which interconnects the casting bases during the pouring of the foundation mass and its subsequent curing, ensures accurate squareness of the casting bases and, thus, of the anchoring bars, thereby limiting manufacturing defects and situations in which the system would be unusable. It also provides the ability to set the horizontality during the concrete pour, making it possible, if necessary, to compensate for any unintentional load or displacement of the casting bases during pouring and curing. This is facilitated by the presence of the upper plates, which can, for example, be maintained as much as possible in a single horizontal plane, the position of each upper plate being visible to the naked eye even during pouring. Advantageously, the system may be prepared in a workshop to be transported and deposited in the correct position in a pit intended to be filled with the foundation mass. This facilitates transport and handling, and improves the reliability of the manufacture of the system, ensuring optimal implementation conditions in a workshop rather than on a construction site, while increasing the stability of the system. Furthermore, this is much safer, as it avoids numerous risks of tipping or crushing for operators in the pit. The system also makes it possible to avoid the need to immobilize the lower part of a vertical mast of the crane while the foundation mass is being carried out. The system is also very simple to use and implement. The system is easy to set, and access to the anchoring bars and to the clamping elements is very convenient. The lower plates, through the anchoring bars and the clamping elements, allow the forces transmitted to the anchorage by the vertical mast to be distributed through the entire foundation mass, thereby conferring good stability.

Some preferred but not exhaustive aspects of this system, which may be taken individually or in combination, are as follows.

The system is such that the foundation mass being intended to be formed on a fixed ground within a terrestrial reference frame, the system includes, at each of the casting bases, a leveling device, cooperating with one of the upper plates and allowing an adjustment of the distance between the fixed ground and the upper plate with which it cooperates.

The adjustment of the distance between the fixed ground and each upper plate by the unitary action of each of the leveling devices fastened to each of the upper plates, makes it possible to position the upper plates within a single geometrically level plane relative to the ground. The adjustment of the leveling devices makes it possible to compensate for local height differences present in the ground across the various areas where the casting bases are arranged. The leveling devices also serve as supports for bearing against the fixed ground within the terrestrial reference frame. Advantageously, the leveling devices make it possible to maintain the system in position relative to the fixed ground for forming an anchorage before and during the arrangement of the foundation mass and allowing real-time adjustment.

Each leveling device may include a bearing base for bearing against the ground, a protective sleeve connecting the upper plate and the lower plate, and a setting rod fastened by screwing to the bearing base and which extends along all or part of a housing delimited by the protective sleeve intended to be isolated from the foundation mass, in such a way as to form a telescopic assembly with adjustable length, the setting rod being mounted to rotate relative to the upper plate and protruding beyond the upper plate on a side opposite the protective sleeve relative to the upper plate.

The protective sleeve of each leveling device surrounding the setting rod is intended to prevent contact between the foundation mass and the setting rod. The absence of contact between the foundation mass and the setting rod allows the setting rod to move freely relative to the foundation mass within the housing delimited by the protective sleeve. The rotational mounting of the upper end of the setting rod on the upper plate is intended to make it possible to adjust the spacing between the bearing base and the upper plate by moving the setting rod along an axis perpendicular to the single plane in which the various upper plates are situated. The bearing bases have a part with a length and width adapted for insertion into the protective sleeve by means of a very small radial mounting clearance, this allows the setting rods to be isolated from the foundation mass by physically preventing the concrete of the foundation mass from penetrating the protective sleeves. The isolation of the setting rods allows the setting rods to be removed after the foundation mass has been formed and after the anchoring has been used during the temporary fastening of a vertical mast of a crane to the foundation mass.

Alternatively, or in combination, the geometric adjustment device includes a plurality of topographic targets in which the number of topographic targets is greater than or equal to 3.

The presence of the topographic targets makes it possible to geometrically adjust the single plane in which the upper plates of the geometric adjustment device are located by setting the leveling devices.

Without limitation, each casting base includes, in a connection area between the lower plate and each connecting sleeve, a protective element cooperating with the lower plate and configured to be able to isolate the first end of one of the anchoring bars from the concrete of the foundation mass.

These provisions ensure that each anchoring bar is completely separate from the concrete used to manufacture the foundation mass, even at its first end. This facilitates the dismounting of each anchoring bar by preventing any local casting with the concrete and also promotes its subsequent reuse without risk of damage.

Each upper plate includes a plurality of openings, each opening being traversed by the second end of one of the anchoring bars, and the system comprises a protective element overlapping the openings and the upper plate and delimiting, in combination with the upper plate, an enclosed volume in which are confined the second ends of the anchoring bars passing through the openings and the clamping elements screwed onto the second ends.

These provisions ensure that each of the anchoring bars and each of the clamping elements are fully protected from the outside, specifically separating them from the concrete used to manufacture the foundation mass, even at the second end. This facilitates the dismounting of each of the anchoring bars by preventing any local casting with the concrete and also promotes its subsequent reuse without risk of damage.

The present disclosure also relates to a method for forming an anchorage making it possible to fasten the lower legs of a vertical mast of a crane to the upper face of a concrete foundation mass, the method including the following steps of:
E1: implementing a system described previously such that the casting bases of the system rest on a fixed ground within a terrestrial reference frame,
E2: carrying out the concrete foundation mass by pouring and curing a quantity of concrete, in such a way that the geometric adjustment device of the system is arranged above the upper face of the foundation mass,
E3: removing the geometric adjustment device from the casting bases in order to make it possible to fasten the vertical mast of the crane, due to the clamping elements, the anchoring bars of the system and the foundation mass.

The placement of the casting bases on a fixed ground within the terrestrial reference frame is intended to prepare the final positioning of the system for forming an anchorage. Connecting the casting bases to the geometric adjustment device allows the casting bases to position the geometric adjustment device on the upper surface of the system for forming an anchorage without the use of traditional lower mast legs. Pouring the concrete foundation mass is intended to carry out a foundation mass that conforms to the outer shape of the assembly formed by the casting bases and the lower surface of the geometric adjustment device. The curing of the concrete of the foundation mass results in the solidification of the concrete. This solidification of the foundation mass is intended to freeze in space the system for forming an anchorage. Removing the geometric adjustment device before installing the lower legs of a vertical mast of a crane makes it possible to reuse the geometric adjustment device in another system for forming a new anchorage. Reusing the geometric adjustment device in another system to form a new anchorage makes it possible to reduce the consumption of high-grade materials that remain in the concrete.

Some preferred but not exhaustive aspects of the method that may be considered individually or in combination are as follows:

Step E1 includes a step E11 including adjusting the geometric adjustment device in such a way that the upper plates are included in a single horizontal plane within the terrestrial reference frame.

These provisions ultimately make it possible to vertically orient the vertical mast of a crane and to balance the crane with respect to the forces acting thereon, and provide the possibility of positioning the protruding second end of the anchoring bars with millimeter precision for receiving the vertical mast of a crane. The setting device makes it possible to dispense with the use of a mast mounted on the casting legs to ensure the verticality tolerance of the anchorage.

When the system includes a leveling device, step E3 may include a step E31 including removing the setting rods from the protective sleeves.

The removal of the setting rods makes it possible to reuse the setting rods in another system for forming another anchorage. This makes it possible to reduce the consumption of high-grade materials for the anchorage of the vertical masts of cranes, resulting also in cost savings and environmental and ecological improvements.

The present disclosure also relates to a method for fastening the lower legs of a vertical mast of a crane to the upper face of a concrete foundation mass, including the following successive phases of:
P1: implementing a method as described above,
P2: removably fastening each of the lower legs secured to said vertical mast, by screwing each of the clamping elements onto the second end of one of the anchoring bars to clamp, at each casting base, one of the lower legs between the clamping element and the upper face of the foundation mass, and
P3: removing the anchoring bars by unscrewing them from the lower plates and sliding them upward relative to the connecting sleeves.

The fastening of the lower legs secured to the vertical mast to the anchoring bars that protrude above the upper face of the foundation mass allows for spatial positioning of the vertical mast and temporarily secures the vertical mast to the foundation mass through the casting bases. The removal of the anchoring bars makes it possible to reuse the anchoring bars in another system to form another anchorage. This makes it possible to reduce the consumption of high-grade materials for the anchorage of the vertical masts of cranes, resulting in cost savings and environmental and ecological improvements. The reuse of the anchoring bars is very effective in reducing the environmental footprint of the anchoring bars on a construction site, since the environmental footprint will be advantageously distributed over several construction sites.

### BRIEF DESCRIPTION OF THE DRAWINGS

Other aspects, objectives, advantages, and features of the present disclosure will become clearer upon reading the following detailed description of preferred embodiments thereof, given by way of non-limiting example, and made with reference to the accompanying drawings in which:

FIG. 1 is a top perspective view of an example of a system for forming an anchorage according to the present disclosure comprising four casting bases.

FIG. 2 is a partial bottom perspective view of the system of FIG. 1 located at one of the casting bases.

FIG. 3 is a perspective view of one of the leveling devices used in the system of FIG. 1.

FIG. 4 is a perspective view of a casting base and part of the leveling device.

FIG. 5 is a perspective view of the geometric adjustment device used in the system of FIG. 1.

FIG. 6 is a perspective view of the system of FIG. 1 partially embedded into a foundation mass made of hardened concrete to constitute an anchorage.

FIG. 7 shows the anchorage of FIG. 6 after removal of the geometric adjustment device and after fastening the lower legs of a vertical mast of a crane to the anchoring bars that protrude above the upper face of the foundation mass.

FIG. 8 is a flowchart schematically representing the sequence of phases and steps of an example of a method according to the present disclosure.

### DETAILED DESCRIPTION

In the figures and throughout the description, the same reference numerals represent identical or similar elements. In addition, the different elements are not represented to scale in order to ensure clarity of the figures. Moreover, the different embodiments and variants are not mutually exclusive and may be combined with each other.

Unless otherwise stipulated, the term “substantially” means, in the present document, “exactly or to within 10% or to within 10°”.

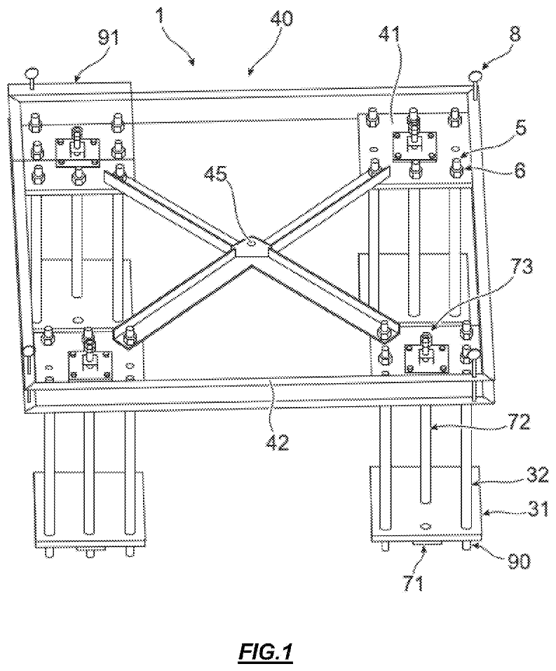

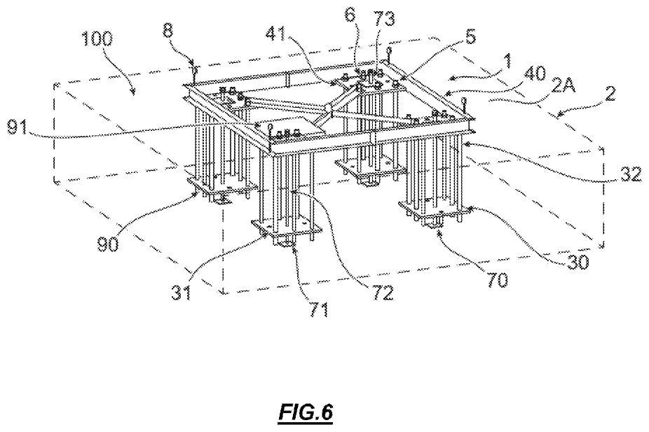

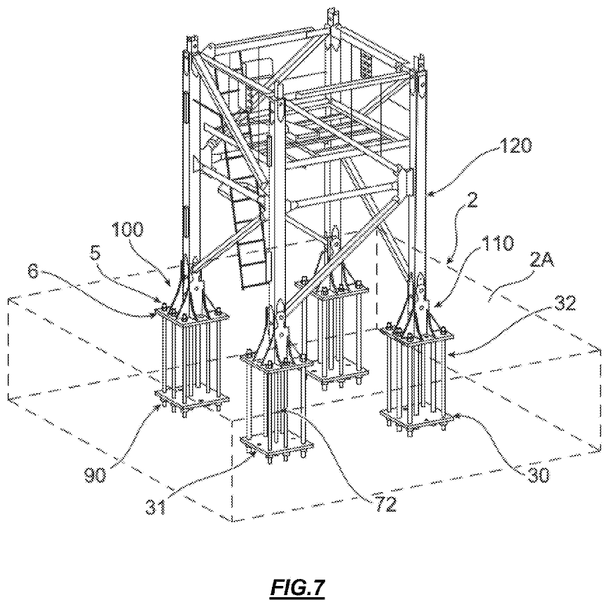

FIGS. 1 and 5 relate to an example of a system 1 according to the present disclosure for forming an anchorage 100 (shown in FIGS. 6 and 7) configured to fasten the lower legs 110 of a vertical mast 120 of a crane to an upper face 2A of a concrete foundation mass 2.

Thus, as can be seen in the figures, the system 1 includes a plurality of casting bases 30. Generally, the number of casting bases 30 is greater than or equal to 3. In the particular case represented, the number of casting bases 30 is, for example, equal to 4. The system 1 may alternatively comprise 3 casting bases 30 or a number greater than or equal to 5. The plurality of casting bases 30 enables a good distribution of the forces and confers good stability to the anchorage 100.

Each casting base 30 includes a lower plate 31 intended to be embedded into the foundation mass 2. Each lower plate 31 typically takes the form of a steel sheet, for example rectangular or square in shape.

Each casting base 30 also includes a plurality of connecting sleeves 32 extending from the lower plate 31. Each connecting sleeve 32 is intended to be at least partially encased (at least in its lower part) into the foundation mass 2. In the particular case as illustrated, each of the casting bases 30 comprises six connecting sleeves 32, but this number may differ from 6 depending on the requirements. Each connecting sleeve 32 internally delimits a pocket intended to be isolated from the foundation mass 2.

As can be seen in the figures, each connecting sleeve 32 is, for example, a tubular profile, for example, made of steel or of a plastic material such as polyvinyl chloride, known by the acronym PVC. The shape and dimensions of the cross-section of such a tubular profile are not limiting here, nor is its length.

Furthermore, as can be seen in the figures, the system 1 includes a geometric adjustment device 40, capable of interconnecting in a removable manner the casting bases 30 with each other. The geometric adjustment device 40 is shown in detail in FIG. 5.

As can be deduced from FIG. 6, the geometric adjustment device 40 is intended to be arranged above the upper face of the foundation mass 2, so that it interconnects the casting bases 30 with each other in their upper parts.

In addition, the geometric adjustment device 40 includes a plurality of upper plates 41. In particular, the geometric adjustment device 40 includes the same number of upper plates 41 as the number of casting bases 30. Thus, in the figures, the number of upper plates 41 is equal to 4, but this number may differ from 4 depending on the requirements. Each upper plate 41 is typically in the form of a steel sheet, for example, rectangular or square. Each upper plate 41 is associated with one of the casting bases 30 and is positioned in contact with the connecting sleeves 32 of the casting base 30 which is associated with it. Thus, for each casting base 30, the connecting sleeves 32 connect the upper plate 41 and the lower plate 31. In other words, the plurality of connecting sleeves 32 that comprise each casting base 30, equal in length, are sandwiched between the lower plate 31 of this casting base 30 and the upper plate 41 associated with this casting base.

In one embodiment as illustrated, the geometric adjustment device 40 includes a frame 42 that interconnects all the upper plates 41 with each other. The frame 42 is, for example, in the form of an assembly of profiles, for example made of metal, arranged between them to delimit a rectangle or square, delimiting a central opening at the angles of which the upper plates 41 are distributed.

Furthermore, the geometric adjustment device 40 may include reinforcing elements 43, such as a cross made up of two metal profiles orthogonal to each other, fastened to the upper plates 41 and intended to provide rigidity to the frame 42 and to the geometric adjustment device 40 as a whole.

The geometric adjustment device 40 may include an attachment member 45 intended to make it possible to lift, transport, and position the system 1 at a desired location. The attachment member 45 may be in the form of a lifting ring, a loop, a hook, or any other equivalent means, such as, for example, in FIGS. 1, 5, and 6, a through hole formed in a sheet located at the center of the cross delimited by the reinforcing elements 43.

The system 1 also includes a plurality of anchoring bars 5. Each anchoring bar 5 has a first end fastened by screwing to the lower plate 31 of one of the casting bases 30 and a second end extending above the upper plate 41 on a side opposite the lower plate 31. As shown in FIGS. 1, 2 and 6, the number of anchoring bars 5 is for example equal to 24, even though this number is in no way limiting. The plurality of anchoring bars 5 is distributed among the different casting bases 30. In other words, the 24 anchoring bars 5 are, for example, uniformly distributed among the 4 casting bases 30, so that 6 anchoring bars 5 are associated with each casting base 30. At each of the 4 casting bases 30, each of the 4 anchoring bars 5 has its first end fastened by screwing to the lower plate 31 of this casting base 30 and its second end extending in protruding above the upper plate 41 associated with this casting base 30.

Each anchoring bar 5 extends inside and along one of the pockets delimited by the connecting sleeves 32 in a removable manner relative to the connecting sleeve 32 which surrounds it, until it protrudes from the upper plate 41 concerned.

In addition, the system 1 includes a plurality of clamping elements 6 screwed onto the second ends of the anchoring bars 5. Each clamping element 6 is intended to create, at the casting base 30 where the anchoring bar 5 onto which it is screwed is arranged, a load from the upper plate 41 toward the lower plate 31 providing a clamping of the connecting sleeves 32.

In a particular case such as visible in FIGS. 1 and 6, it may be provided that the reinforcing elements 43 of the geometric adjustment device 40 are, on the one hand, placed against the upper surface of the upper plates 41 by inserting themselves around some of the anchoring bars 5 and, on the other hand, clamped between the upper plates 41 and the clamping elements 6 screwed onto the second ends of these anchoring bars 5.

As illustrated in FIG. 6, the system 1 is such that the foundation mass 2 is intended to be formed on a fixed ground within a terrestrial reference frame. This foundation mass 2 is obtained by pouring and curing an appropriate quantity of concrete in a suitable formwork positioned on the ground at the location where the crane is intended to be subsequently positioned.

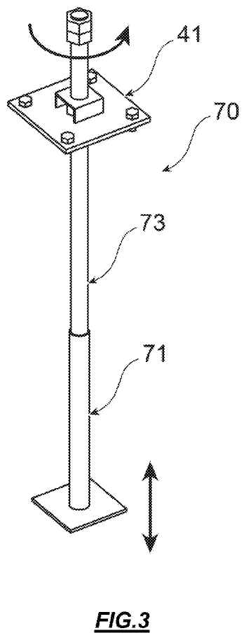

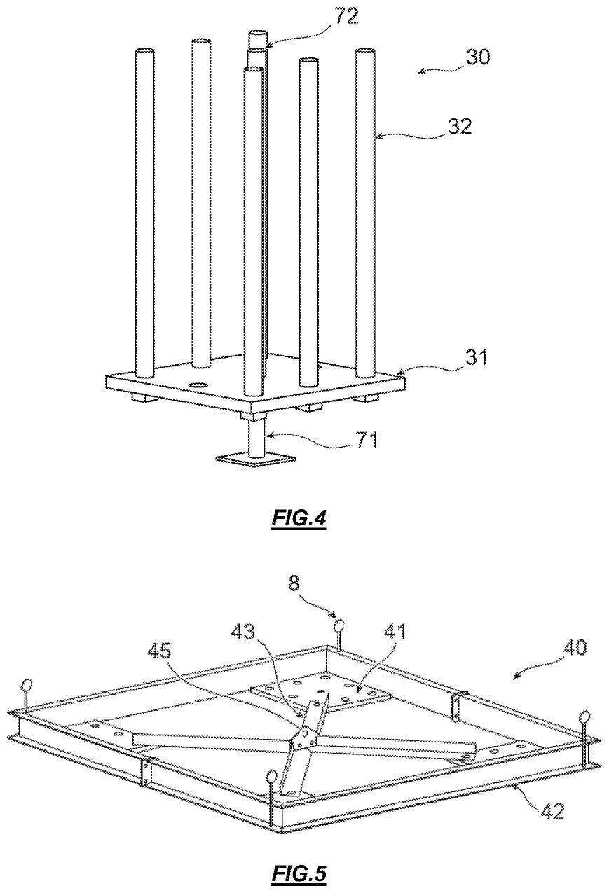

Furthermore, the system 1 includes, at each of the casting bases 30, a leveling device 70, shown in detail in FIG. 3 and partially in FIG. 4. Each leveling device 70 thus cooperates with one of the upper plates 41 to locally adjust the distance between the fixed ground and the upper plate 41 concerned and, for this purpose, includes a bearing base 71 for bearing against the ground and a protective sleeve 72 connecting the upper plate 41 and the lower plate 31. Each protective sleeve 72 is, for example, a tubular profile, for example, made of steel or a plastic material such as polyvinyl chloride PVC. The shape and dimensions of the cross-section of such a tubular profile are not limited here, nor is its length. Each leveling device 70 also includes a setting rod 73 fastened by screwing to the bearing base 71 and which extends along all or part of a housing delimited by the protective sleeve 72. This housing is intended to be isolated from the foundation mass 2, as can be seen in FIG. 6.

According to an important feature, the bearing base 71, the protective sleeve 72, and the setting rod 73 of the leveling device 70 are arranged so as to form a telescopic assembly with adjustable length. This is made possible by the fact that the setting rod 73 is mounted for rotation relative to the upper plate 41 and protrudes beyond the upper plate 41 on the side opposite the protective sleeve 72 relative to the upper plate 41. A rotation of the setting rod, symbolized by the arrow in the upper part of FIG. 3, implies an extension or retraction movement, symbolized by the double-headed arrow of the lower part of FIG. 3.

The geometric adjustment device 40 comprises a plurality of topographic targets 8, the number of which will advantageously be at least 3 in order to allow for accurate 3D positioning. The variant shown thus comprises 4 topographic targets 8, for example arranged at the corners of the frame 42.

Each casting base 30 includes, in a connection area between the lower plate 31 and each connecting sleeve 32, a protective element 90 cooperating with the lower plate 31 and configured to be able to isolate the first end of one of the anchoring bars 5 from the concrete of the foundation mass 2. The isolation of the first ends of the anchoring bars 5 from the concrete foundation mass 2 may be advantageously facilitated by the use of a lubricant or grease at the protective element 90, which also makes it easier to dismount the anchoring bars 5.

As visible in FIG. 5, each upper plate 41 includes a plurality of openings, each of these openings being traversed by the second end of one of the anchoring bars 5. The clamping element 6 screwed onto the second end of the anchoring bar 5 exerts pressure forces on the contours of this opening, with or without the interposition of a bearing washer.

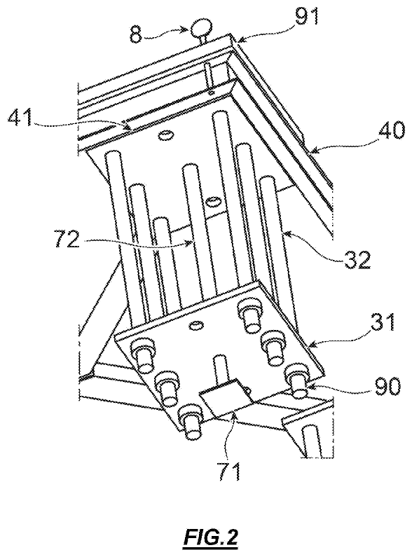

As can be seen in FIGS. 1 and 2, a protective element 91 overlaps the openings mentioned in the previous paragraph as well as the upper plate 41 and delimits, in combination with the latter, an enclosed volume in which are confined the second ends of the anchoring bars 5 and the clamping elements 6 screwed onto the second ends.

The confinement conferred by the protective elements 91 may be supplemented by the use of a lubricant or grease at the contact interface between the protective element 91 and the upper plate 41 that it overlaps.

In an advantageous embodiment, the formation of an anchorage 100 using the system 1 is carried out by a method which includes a step E1 including placing the system 1 so that its various casting bases 30 rest on the fixed ground, as is the case in the example of FIG. 6. This step E1 may be carried out through the attachment member 45 secured to the system 1, described previously.

In a preferred scenario, step E1 includes step E11, including adjusting the geometric adjustment device 40 in such a way that the upper plates 41 are included in a single horizontal plane within the terrestrial reference frame. This step E11 is carried out, in particular, by using the topographic targets 8. This makes it possible to obtain a foundation mass 2 whose upper face 2A is flat and horizontal.

The formation of the anchorage 100 may include the implementation of a step E2, after step E1, including carrying out the concrete foundation mass 2 by pouring and curing the quantity of concrete, in such a way that the geometric adjustment device 40 is then arranged, after step E2, above the upper face 2A of the foundation mass 2 as illustrated in the example of FIG. 6.

In addition, the formation of the anchorage 100 may include the implementation of a step E3, after step E2, including removing the geometric adjustment device 40 from the casting bases 30 in order to allow the vertical mast 120 of the crane to be fastened, due to the clamping elements 6, the anchoring bars 5 and the foundation mass 2. FIG. 7 illustrates the result of this step E3, after the removal of the geometric adjustment device 40 previously shown in FIG. 6.

In a preferred embodiment, step E3 including a step E31 including removing the setting rods 73 from the protective sleeves 72, as illustrated in FIG. 7.

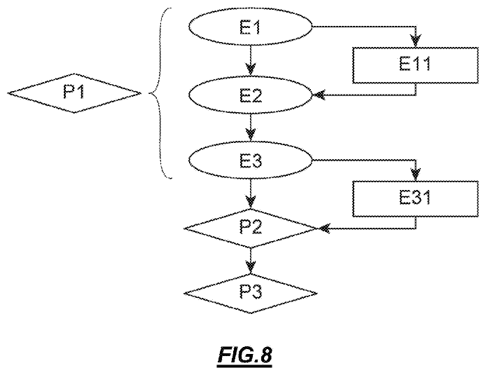

When it is necessary to fasten the lower legs 110 of a vertical mast 120 of a crane to the upper face 2A of a concrete foundation mass 2, a method may be implemented including implementing, in a first phase P1, the steps E1 to E3 described previously. FIG. 8 is a flowchart representing the sequence to be implemented for this method, with in particular the successive implementation of steps E1, E2, and E3 in order to obtain the anchorage 100, in order to then allow the fastening of the lower legs 110.

Thus, as shown schematically in FIG. 8, phase P1 is followed by a second phase P2 including fastening each of the lower legs 110 secured to the vertical mast 120 in a removable manner, by screwing each of the clamping elements 6 onto the second end of one of the anchoring bars 5 to clamp, at each casting base 30, one of the lower legs 110 between the clamping elements 6 and the upper face 2A of the foundation mass 2. In FIG. 7, the 4 lower legs 110 secured to the vertical mast 120 have been fastened by screwing each of the clamping elements 6 onto the second end of the anchoring bars 5 to clamp, at each casting base 30, one of the lower legs 110 between the clamping elements 6 and the upper face 2A of the foundation mass 2.

Phase P2 may provide the insertion of intermediate elements between the foundation mass 2 and each of the lower legs 110, and/or the insertion of intermediate elements between the clamping elements 6 and the lower legs 110. With reference to FIG. 8, after dismantling the fastening of the lower legs 110 from the foundation mass 2 (which dismantling is obtained by unscrewing the clamping elements 6), phase P2 is followed by a third phase P3 including removing the anchoring bars 5 by unscrewing them from the lower plates 31 and sliding them upward relative to the connecting sleeves 32.

1. A system for forming an anchorage configured to fasten the lower legs of a vertical mast of a crane to an upper face of a concrete foundation mass, the system comprising:
a plurality of casting bases wherein a number of casting bases is greater than or equal to 3, each of the casting bases comprising:
a lower plate intended to be embedded into the foundation mass; and
a plurality of connecting sleeves extending from the lower plate and intended to be at least partially encased into the foundation mass;
a geometric adjustment device, interconnecting in a removable manner the casting bases with each other, intended to be arranged above the upper face of the foundation mass and comprising a plurality of upper plates, each upper plate being associated with one of the casting bases and being positioned in contact with the connecting sleeves of the casting base which is associated with it, so that, for each casting base, the connecting sleeves connect the upper plate and the lower plate and each connecting sleeve internally delimits a pocket intended to be isolated from the foundation mass;
a plurality of anchoring bars having a first end fastened by screwing to the lower plate of one of the casting bases and a second end extending above the upper plate on a side opposite the lower plate and intended to protrude above the upper face of the foundation mass, each anchoring bar extending along one of the pockets delimited by the connecting sleeves in a manner removable from the connecting sleeve which surrounds it; and
a plurality of clamping elements screwed onto the second ends of the anchoring bars and each intended to create, at one of the casting bases, a load from the upper plate toward the lower plate so as to clamp the connecting sleeves.

2. The system according to claim 1, wherein the foundation mass being intended to be formed on a fixed ground within a terrestrial reference frame, the system comprises, at each of the casting bases, a leveling device, cooperating with one of the upper plates and allowing an adjustment of a distance between the fixed ground and the upper plate with which it cooperates.

3. The system according to claim 2, wherein each leveling device comprises a bearing base for bearing against the ground, a protective sleeve connecting the upper plate and the lower plate, and a setting rod fastened by screwing to the bearing base and which extends along all or part of a housing delimited by the protective sleeve intended to be isolated from the foundation mass, in such a manner as to form a telescopic assembly with an adjustable length, the setting rod being mounted for rotation with respect to the upper plate and protruding beyond the upper plate on a side opposite the protective sleeve relative to the upper plate.

4. The system for forming an anchorage according to claim 1, wherein the geometric adjustment device comprises a plurality of topographic targets in which the number of topographic targets is greater than or equal to 3.

5. The system according to claim 1, wherein each casting base comprises, in a connection area between the lower plate and each connecting sleeve, a protective element cooperating with the lower plate and configured to be able to isolate the first end of one of the anchoring bars from the concrete of the foundation mass.

6. The system according to claim 1, wherein each upper plate comprises a plurality of openings, each opening being traversed by the second end of one of the anchoring bars, and wherein the system comprises a protective element overlapping the openings and the upper plate and delimiting, in combination with the upper plate, an enclosed volume in which are confined the second ends of the anchoring bars passing through the openings and the clamping elements screwed onto the second ends.

7. A method for forming an anchorage making it possible to fasten the lower legs of a vertical mast of a crane to an upper face of a concrete foundation mass, the method including the steps of:
implementing a system such that casting bases of the system rest on a fixed ground within a terrestrial reference frame, wherein the system comprises
a plurality of casting bases wherein a number of casting bases is greater than or equal to 3, each of the casting bases comprising
a lower plate intended to be embedded into the foundation mass; and
a plurality of connecting sleeves extending from the lower plate and intended to be at least partially encased into the foundation mass;
a geometric adjustment device, interconnecting in a removable manner the casting bases with each other, intended to be arranged above the upper face of the foundation mass and comprising a plurality of upper plates, each upper plate being associated with one of the casting bases and being positioned in contact with the connecting sleeves of the casting base which is associated with it, so that, for each casting base, the connecting sleeves connect the upper plate and the lower plate and each connecting sleeve internally delimits a pocket intended to be isolated from the foundation mass;
a plurality of anchoring bars having a first end fastened by screwing to the lower plate of one of the casting bases and a second end extending above the upper plate on a side opposite the lower plate and intended to protrude above the upper face of the foundation mass, each anchoring bar extending along one of the pockets delimited by the connecting sleeves in a manner removable from the connecting sleeve which surrounds it;
a plurality of clamping element screwed onto the second ends of the anchoring bars and each intended to create, at one of the casting bases, a load from the upper plate toward the lower plate so as to clamp the connecting sleeves;
carrying out the foundation mass by pouring and curing a quantity of concrete, in such a way that the geometric adjustment device of the system is arranged above the upper face of the foundation mass; and
removing the geometric adjustment device from the casting bases in order to allow the vertical mast of the crane to be fastened, due to the clamping elements, the anchoring bars of the system and the foundation mass.

8. The method according to claim 7, wherein implementing the system such that the casting bases of the system rest on the fixed ground within the terrestrial reference frame comprises adjusting the geometric adjustment device in such a way that the upper plates are included in a single horizontal plane within the terrestrial reference frame.

9. The method according to claim 7, wherein the system further comprises
at each of the casting bases, a leveling device cooperating with one of the upper plates and allowing an adjustment of a distance between the fixed ground and the upper plate with which it cooperates, wherein each leveling device comprises a bearing base for bearing against the ground, a protective sleeve connecting the upper plate and the lower plate, and a setting rod fastened by screwing to the bearing base and which extends along all or part of a housing delimited by the protective sleeve intended to be isolated from the foundation mass in such a manner as to form a telescopic assembly with an adjustable length, the setting rod being mounted for rotation with respect to the upper plate and protruding beyond the upper plate on a side opposite the protective sleeve relative to the upper plate; and
wherein removing the geometric adjustment device form the casting bases comprises removing the setting rods from the protective sleeves.

10. A method for fastening the lower legs of a vertical mast of a crane to an upper face of a concrete foundation mass, comprising:
implementing a first phase comprising implementing a system such that casting bases of the system rest on a fixed ground within a terrestrial reference frame, wherein the system comprises
a plurality of casting bases wherein a number of casting bases is greater than or equal to 3, each of the casting bases comprising
a lower plate intended to be embedded into the foundation mass; and
a plurality of connecting sleeves extending from the lower plate and intended to be at least partially encased into the foundation mass;
a geometric adjustment device, interconnecting in a removable manner the casting bases with each other, intended to be arranged above the upper face of the foundation mass and comprising a plurality of upper plates, each upper plate being associated with one of the casting bases and being positioned in contact with the connecting sleeves of the casting base which is associated with it, so that, for each casting base, the connecting sleeves connect the upper plate and the lower plate and each connecting sleeve internally delimits a pocket intended to be isolated from the foundation mass;
a plurality of anchoring bars having a first end fastened by screwing to the lower plate of one of the casting bases and a second end extending above the upper plate on a side opposite the lower plate and intended to protrude above the upper face of the foundation mass, each anchoring bar extending along one of the pockets delimited by the connecting sleeves in a manner removable from the connecting sleeve which surrounds it; and
a plurality of clamping element screwed onto the second ends of the anchoring bars and each intended to create, at one of the casting bases, a load from the upper plate toward the lower plate so as to clamp the connecting sleeves;
the first phase further comprising carrying out the foundation mass by pouring and curing a quantity of concrete in such a way that a geometric adjustment device of the system is arranged above the upper face of the foundation mass;
implementing a second phase comprising removably fastening each of the lower legs secured to said vertical mast, by screwing each of the clamping elements onto the second end of one of the anchoring bars to clamp, at each casting base, one of the lower legs between the clamping element and the upper face of the foundation mass; and
implementing a third phase comprising removing the anchoring bars by unscrewing them from the lower plates and sliding them upward relative to the connecting sleeves.

11. The method according to claim 10, wherein implementing the system such that the casting bases of the system rest on the fixed ground within the terrestrial reference frame comprises adjusting the geometric adjustment device in such a way that the upper plates are included in a single horizontal plane within the terrestrial reference frame.

12. The method according to claim 10, wherein the system further comprises:
at each of the casting bases, a leveling device cooperating with one of the upper plates and allowing an adjustment of a distance between the fixed ground and the upper plate with which it cooperates, wherein each leveling device comprises a bearing base for bearing against the ground, a protective sleeve connecting the upper plate and the lower plate, and a setting rod fastened by screwing to the bearing base and which extends along all or part of a housing delimited by the protective sleeve intended to be isolated from the foundation mass in such a manner as to form a telescopic assembly with an adjustable length, the setting rod being mounted for rotation with respect to the upper plate and protruding beyond the upper plate on a side opposite the protective sleeve relative to the upper plate; and
wherein removing the geometric adjustment device form the casting bases comprises removing the setting rods from the protective sleeves.
